(19) United States
(12) Patent Application Publication
(10) Pub. No.: US 2014/0232177 A1
(43) Pub. Date: Aug. 21, 2014

(54) AXLE ASSEMBLY AND A METHOD OF MANUFACTURE

(71) Applicant: ARVINMERITOR TECHNOLOGY, LLC, Troy, MI (US)

(72) Inventor: Michael Andrew Power, Troy, MI (US)

(73) Assignee: ARVINMERITOR TECHNOLOGY, LLC, Troy, MI (US)

(21) Appl. No.: 13/767,915

(22) Filed: Feb. 15, 2013

(51) Int. Cl. B60B 35/04; B62D 65/00; B60G 9/00

(52) U.S. Cl. CPC B60B 35/04; B60G 9/006; B62D 65/00
USPC 301/131; 29/525.01

(57) ABSTRACT

An axle assembly and a method of manufacture. The axle assembly may have an axle tube that may be formed to increase a wall thickness of an end portion. A spindle may be fastened to the end portion with a fastener that is received in the fastener hole in the end portion.

### TECHNICAL FIELD

This patent application relates to an axle assembly and a method of manufacture.

### BACKGROUND

A method of fabricating an axle housing assembly is disclosed in U.S. Pat. No. 7,461,454.

### SUMMARY

In at least one embodiment, a method of manufacturing an axle assembly is provided. The method may include providing an axle tube that may extend along an axis and may have a nominal wall thickness. An end portion of the axle tube may be formed that has an end portion wall thickness. The end portion wall thickness may extend from a first end of the axle tube toward a second end of the axle tube and may be greater than the nominal wall thickness. A fastener hole may be provided in the end portion. A spindle may be fastened to the end portion with a fastener that may be received in the fastener hole.

In at least one embodiment, a method of manufacturing an axle assembly is provided. The method may include providing a hollow cylindrical axle tube having a nominal wall thickness. The axle tube may be inserted into a hole in a suspension arm. The axle tube may be hydroformed against the suspension arm to fixedly position the axle tube with respect to the suspension arm. An end portion of the axle tube may be hydroformed to provide an end portion wall thickness that may be greater than the nominal wall thickness and that may extend from a first end of the axle tube toward the suspension arm. A fastener hole may be provided in the end portion that extends from the first end toward the suspension arm. A spindle for supporting a wheel hub assembly may be positioned proximate the first end and may be fastened to the end portion with a fastener that is received in the fastener hole.

In at least one embodiment, an axle assembly is provided. The axle assembly may have a suspension arm, a unitary axle tube, and a spindle. The suspension arm may have a first surface, a second surface, and a hole that extends from the first surface to the second surface. The axle tube may extend along an axis through the hole. The axle tube may have a nominal wall thickness proximate the hole and an end portion. The end portion may be disposed at a first end of the axle tube and may have an end portion wall thickness that is greater than the nominal wall thickness. The spindle may be fixedly mounted to the end portion.

### BRIEF DESCRIPTION OF THE DRAWINGS

FIG. 1 is a perspective view of an exemplary axle assembly.

FIGS. 2-5 are section views depicting a method of manufacturing an axle assembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

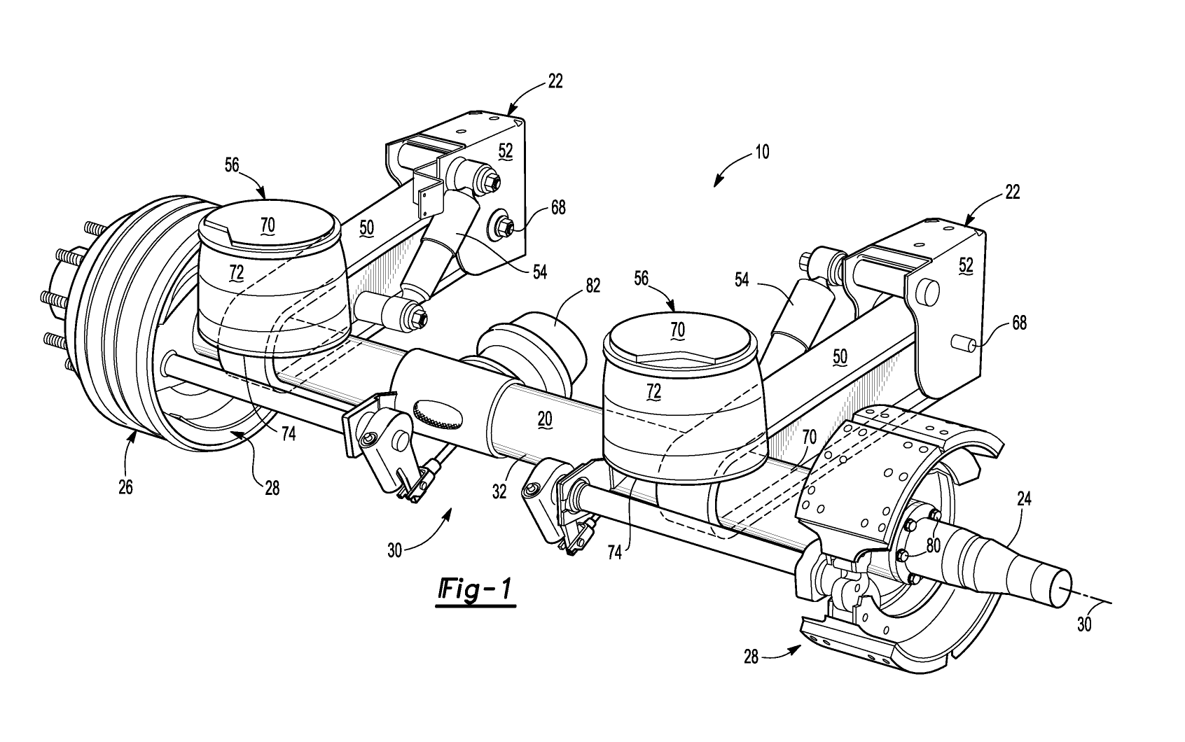

Referring to FIG. 1, an exemplary axle assembly 10 is shown. The axle assembly 10 may be provided with a vehicle, such as a truck or truck trailer that may be used to transport cargo. The axle assembly 10 may include an axle tube 20, at least one suspension arm assembly 22, a spindle 24, a wheel hub assembly 26, and a brake subsystem 28.

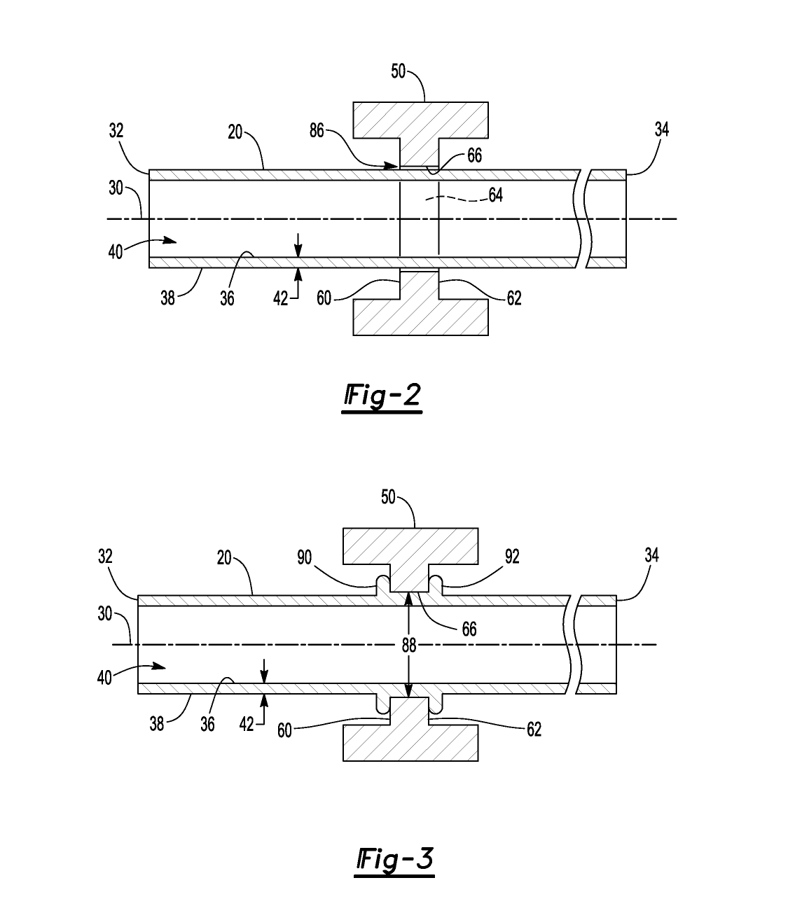

Referring to FIGS. 1 and 2, the axle tube 20 may extend along an axis 30. The axle tube 20 may have a unitary or one-piece construction that may include a first end 32, a second end 34, an interior surface 36, and an exterior surface 38. The first end 32 may be disposed opposite the second end 34. The interior surface 36 may extend from the first end 32 to or toward the second end 34 and may define a through hole 40 that may extend through the axle tube 20. As such, the axle tube 20 may be hollow and may have a unitary or one piece construction. The exterior surface 38 may be disposed opposite the interior surface 36 and may also extend from the first end 32 to or toward the second end 34. The exterior surface 38 may be an exterior circumference of the axle tube 20. As such, the axle tube 20 may initially have a cylindrical configuration that may have a substantially constant initial wall thickness or nominal wall thickness 42. The nominal wall thickness 42 may be the thickness of the axle tube 20 from the interior surface 36 to the exterior surface 38. The nominal wall thickness 42 may extend radially with respect to the axis 30 and may be substantially constant from the first end 32 to the second end 34 prior to forming as will be discussed in more detail below. The axle tube 20 may be made of aluminum or an aluminum alloy to provide reduced weight and improved corrosion characteristics as compared to steel or a ferrous metal alloy. The axle tube 20 may be formed to increase the wall thickness at least one end to facilitate mounting of the spindle 24 as will be discussed in more detail below.

One or more suspension arm assemblies 22, which may also called trailing suspension arm assemblies, may be mounted on the axle tube 20. In FIG. 1, two suspension arm assemblies 22 are shown that are spaced apart from each other. Each suspension arm assembly 22 may include a suspension arm 50, a hanger 52, a shock absorber 54, and an air spring 56.

The suspension arm 50 may be fixedly coupled to the axle tube 20. As is best shown in FIG. 2, the suspension arm 50 may have a first surface 60, a second surface 62, and a hole 64. The first surface 60 may be disposed opposite the second surface 62. The hole 64 may extend from the first surface 60 to or toward the second surface 62. As such, the suspension arm 50 may have an inner surface 66 that at least partially defines the hole 64. In FIG. 2, the suspension arm 50 has an I-beam configuration, but may be provided with other constructions. For instance, the suspension arm 50 may have a box-like construction and may be hollow or have a void between the first and second surfaces 60, 62.

The hanger 52 may be pivotally disposed at an end of the suspension arm 50. The hanger 52 may be configured to be mounted to a support frame of the vehicle or chassis of the trailer. The hanger 52 may receive a pivot pin 68 that may extend through the hanger 52 and the suspension arm 50. As such, the suspension arm 50 may pivot about the pivot pin 68 and pivot with respect to the hanger 52.

The shock absorber 54 may be provided to dampen shock impulses and dissipate kinetic energy. The shock absorber 54 may be mounted to the hanger 52 at a first end and mounted to the suspension arm 50 at a second end.

An air spring 56 may be disposed proximate an end of the suspension arm 50 that is disposed opposite the hanger 52. The air spring 56 may receive a pressurized gas and may be configured to absorb shocks and vibrations to improve ride quality. The air spring 56 may be disposed above the axle tube 20 and may have a top plate 70 that may be disposed proximate the support frame of the vehicle or chassis of a trailer. A flexible bellows 72 may extend from the top plate 70 to or toward a bottom plate 74 that may be disposed opposite the top plate 70. The top plate 70, flexible bellows 72, and bottom plate 74 may cooperate to at least partially define a chamber within the air spring 56 that may receive pressurized gas.

A spindle 24 may be provided one or more ends of the axle tube 20. In FIG. 1, a spindle 24 is provided at opposite ends of the axle tube 20, but a single spindle 24 may be provided in other configurations or with a shorter axle tube 20. Each spindle 24 may rotatably support a wheel hub assembly 26 that may include a wheel upon which a tire is mounted. The spindle 24 may be made of a different material than the axle tube 20. For instance, the spindle 24 may be made of steel or a ferrous metal alloy to provide sufficient strength and wear characteristics. As such, the spindle 24 may be affixed or coupled to the axle tube 20 without welding in one or more embodiments. For instance, the spindle 24 may be fixedly mounted to an end portion of the axle tube 20 with one more fasteners 80, such as a threaded fastener like a bolt, as will be discussed in more detail below.

The brake subsystem 28 may be provided to brake or inhibit rotation of an associated wheel hub assembly 26. The brake subsystem 28 may be fixedly disposed on the axle tube 20 and may be spaced apart from a suspension arm assembly 22. In at least one embodiment, the brake subsystem 28 may be configured with a drum brake assembly that may be coupled to an actuator 82 that may be configured to actuate a brake pad.

Referring to FIGS. 2-5, a method of manufacturing an axle assembly will now be discussed in more detail.

Referring to FIG. 2, the method may begin by providing the axle tube 20. The axle tube 20 may initially have a nominal wall thickness 42 as previously discussed.

The axle tube 20 may be formed to fixedly couple the axle tube 20 to another component, such as at least one suspension arm 50. Forming of the axle tube 20 may include a plurality of steps.

First, the axle tube 20 may be positioned in the hole 64 in the suspension arm 50 as illustrated in FIG. 2. The axle tube 20 may be initially sized such that the axle tube 20 is smaller than the hole 64 to facilitate insertion of the axle tube 20 into the hole 64. As such, there may be a clearance fit or gap 86 between the axle tube 20 and the suspension arm 50, or between the exterior surface 38 and inner surface 66.

Next, the axle tube 20 may be formed to fixedly couple the axle tube 20 to the suspension arm 50 as illustrated in FIG. 3. For instance, the axle tube 20 may be hydroformed to expand the axle tube 20 outwardly away from the axis 30 such that the exterior surface 38 may engage and continuously mate with the inner surface 66 of the suspension arm 50 as is best shown by comparing FIGS. 2 and 3. Expansion of the axle tube 20 against the suspension arm 50 may inhibit axial and/or rotational movement of the axle tube 20 with respect to the suspension arm 50. For instance, the axle tube 20 may be expanded with sufficient force that friction between the exterior surface 38 of the axle tube 20 and the inner surface 66 of the suspension arm 50 is sufficient to inhibit axial and/or rotational movement. The hole 64 in the suspension arm 50 may have a circular configuration or a non-circular configuration. A hole 64 having a non-circular configuration may inhibit rotational movement of the axle tube 20 to a greater degree than a circular hole. More specifically, the axle tube 20 may be expanded to continuously mate against the non-circular inner surface 66 of the hole 64, thereby providing an interlocking geometry that resists rotational movement. In an embodiment having a hole 64 with a circular configuration, the outside diameter 88 of the axle tube 20 or exterior surface 38 that is disposed in the hole 64 may be larger after forming than before forming.

As is also shown in FIG. 3, the axle tube 20 may also be provided with one or more protrusions to inhibit axial movement, or movement of the axle tube 20 along the axis 30 with respect to the suspension arm 50. In FIG. 3, first and second protrusions 90, 92 are shown that extend away from the axis 30 further than an adjacent region of the axle tube 20 or an initial diameter of the axle tube 20. As such, the first and/or second protrusions 90, 92 may extend outwardly from the axis 30 further than the portion of the axle tube 20 that is disposed in the hole 64 and formed or expanded against the suspension arm 50 in one or more embodiments. The first and second protrusions 90, 92 may extend radially and may be spaced apart from each other or spaced apart in a direction extending along the axis 30. In at least one embodiment, the first and second protrusions 90, 92 may be disposed proximate or may engage different surfaces of the suspension arm 50. For instance, the first protrusion 90 may be disposed proximate or may engage a first surface 60 of the suspension arm 50 and the second protrusion 92 may be disposed proximate or may engage a second surface 62 of the suspension arm 50. The first and second protrusions 90, 92 may be localized or continuous. More specifically, the first and second protrusions 90, 92 may be configured as a localized bulge that does not extend continuously around the axis 30 or may be configured as a ring that extends continuously around the axis 30.

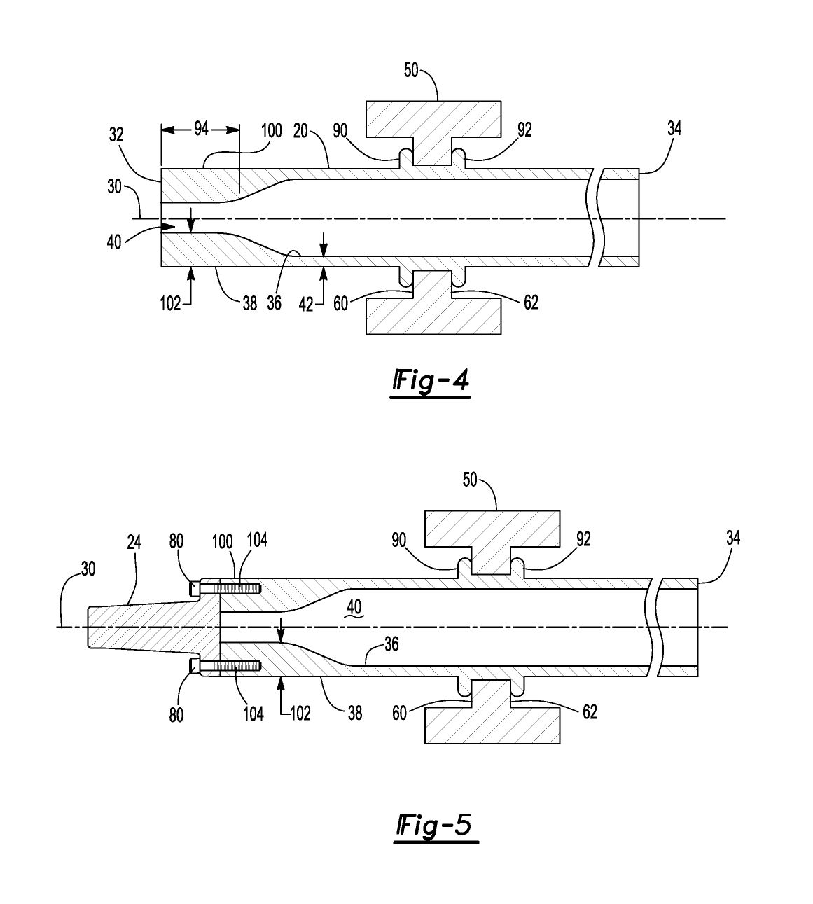

Referring to FIG. 4, the axle tube 20 may be formed to provide at least one end portion 100 that has an increased wall thickness. An end portion 100 may be provided at a single end or at opposite ends of the axle tube 20. For instance, an end portion 100 may extend from the first end 32 toward the second end 34 and vice versa. The end portion 100 may be formed using the same manufacturing process that is used to form the axle tube 20 against the suspension arm 50. For instance, the end portion 100 may be hydroformed. In addition, the end portion 100 may be formed before, after or at approximately the same time as the axle tube 20 is formed to the suspension arm 50.

The end portion 100 may have an end portion wall thickness 102 that is greater than the nominal wall thickness 42 or a wall thickness of an adjacent portion of the axle tube 20. The end portion wall thickness 102 may be increased or thickened in a direction extending toward the axis 30. As such, the outside diameter of the axle tube 20 at the end portion 100 may remain substantially constant while the inside diameter of the axle tube 20 or diameter of the interior surface 36 and through hole 40 may decrease. The end portion wall thickness 102 may extend over a predetermined distance 94 or portion of the length of the axle tube 20. For instance, the end portion wall thickness 102 may extend from the first end 32 of the axle tube 20 partially toward the second end 34 of the axle tube 20 and/or vice versa. In addition, the end portion wall thickness 102 may be formed as a solid, thickened ring that may extend continuously around the axis 30 and may be free of voids. In FIG. 4, the end portion wall thickness 102 is spaced apart from the suspension arm 50.

Referring to FIG. 5, the end portion 100 may be prepared to receive a spindle 24 after forming. For example, material may also be removed from the first end 32 and/or second end 34 of the axle tube 20 to provide a substantially planar surface to facilitate mounting of the spindle 24. The end portion 100 may also be provided with a set of one or more fastener holes 104. Each member of the set of fastener holes 104 may extend axially from the first end 32 toward the second end 34 or vice versa. In addition, the fastener holes 104 may extend partially into or through the end portion wall thickness 102. As such, the fastener holes 104 may be blind holes that may extend toward and may be spaced apart from the suspension arm 50. It is also contemplated that that non-axial fastener holes may be provided. A fastener hole 104 may be tapped or provided with one or more threads that may mate with corresponding threads of a fastener 80 to secure the spindle 24 to the axle tube 20 free of welding. As such, a durable spindle 24 may be provided with a lighter weight axle tube 20 as compared to a steel axle tube or all-steel axle assembly.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of manufacturing an axle assembly comprising:
providing an axle tube that extends along an axis and has a first end and a second end, wherein the axle tube has a nominal wall thickness;
forming an end portion of the axle tube to provide an end portion wall thickness that is greater than the nominal wall thickness, wherein the end portion wall thickness extends from the first end toward the second end;
providing a fastener hole in the end portion; and
fastening a spindle to the end portion with a fastener that is received in the fastener hole.

2. The method of claim 1 further comprising positioning the axle tube in a hole in a suspension arm before forming the end portion.

3. The method of claim 2 further comprising forming the axle tube against the suspension arm to fixedly position the axle tube with respect to the suspension arm after positioning the axle tube in the hole in the suspension arm.

4. The method of claim 3 wherein forming the axle tube against the suspension arm includes expanding the axle tube away from the axis such that an exterior surface of the axle tube is forced against a surface of the suspension arm that defines the hole.

5. The method of claim 4 wherein an outside diameter of the axle tube located inside the hole is increased when the exterior surface of the axle tube is formed against the surface of the suspension arm.

6. The method of claim 3 wherein forming the axle tube against the suspension arm includes forming first and second protrusions on the axle tube that extend away from the axis and are disposed proximate the suspension arm to inhibit axial movement of the axle tube with respect to the suspension arm.

7. The method of claim 6 wherein the first and second protrusions engage first and second surfaces of the suspension arm that are disposed opposite each other and at least partially define the hole.

8. The method of claim 6 wherein the first protrusion extends further away from the axis than a portion of an exterior surface of the axle tube that is disposed in the hole in the suspension arm.

9. The method of claim 6 wherein the first protrusion is configured as a ring that extends continuously around the axle tube.

10. A method of manufacturing a trailer axle assembly comprising:
providing a hollow cylindrical axle tube having a nominal wall thickness;
inserting the axle tube into a hole in a suspension arm;
hydroforming the axle tube against the suspension arm to fixedly position the axle tube with respect to the suspension arm;
hydroforming an end portion of the axle tube to provide an end portion wall thickness that is greater than the nominal wall thickness and extends from a first end of the axle tube toward the suspension arm;
providing a fastener hole in the end portion that extends from the first end toward the suspension arm;
positioning a spindle for supporting a wheel hub assembly proximate the first end; and
fastening a spindle to the end portion with a fastener that is received in the fastener hole.

11. The method of claim 10 wherein hydroforming the axle tube against the suspension arm occurs substantially simultaneously with hydroforming the end portion.

12. The method of claim 10 wherein the axle tube has a smaller diameter than the hole in the suspension arm before hydroforming the axle tube against the suspension arm.

13. The method of claim 10 wherein the end portion wall thickness is spaced apart from the suspension arm.

14. The method of claim 10 wherein the hole in the suspension arm is non-circular and wherein the axle tube is non-circular after hydroforming the axle tube against the suspension arm.

15. The method of claim 10 wherein hydroforming the axle tube against the suspension arm inhibits axial and rotational movement of the axle tube with respect to the suspension arm.

16. The method of claim 10 wherein the axle tube is made of an aluminum alloy, the spindle is made of steel, and the axle tube is coupled to the spindle and suspension arm free of welding.

17. An axle assembly comprising:
a suspension arm having a first surface, a second surface, and a hole that extends from the first surface to the second surface;
a unitary axle tube that extends along an axis through the hole, the axle tube having a nominal wall thickness proximate the hole and an end portion disposed at a first end of the axle tube having an end portion wall thickness that is greater than the nominal wall thickness; and
a spindle that is fixedly mounted to the end portion.

18. The axle assembly of claim 17 wherein the axle tube includes first and second protrusions that extend outwardly away from the axis, wherein the first and second protrusions are spaced apart from each other and engage the first and second surfaces, respectively, to inhibit axial movement of the axle tube through the hole.

19. The axle assembly of claim 18 wherein the first and second protrusions extend continuously around the axis.

20. The axle assembly of claim 17 wherein the end portion includes a set of fastener holes that extend from the first end into the end portion wall thickness, wherein each member of the set of fastener holes receives a fastener that couples the spindle to the axle tube.
